(19) United States
(12) Patent Application Publication
(10) Pub. No.: US 2026/0039948 A1
(43) Pub. Date: Feb. 5, 2026

(54) USER GUIDANCE FOR IMAGE CAPTURING USING A DISPLAY FREE BODY WEARABLE COMPUTING DEVICE

(71) Applicant: Dell Products L.P., Round Rock, TX (US)

(72) Inventors: SI FI FAYE LI, Singapore (SG); SEUNGMI LEE, Singapore (SG); MICHIEL SEBASTIAAN EMANUEL PETRUS KNOPPERT, Amsterdam (NL); JOHYUN MOON, Singapore (SG); CHIN LEONG ONG, Singapore (SG); YAN YAN, Singapore (SG); PRABU SELVARAJ, Singapore (SG); WEIYI WANG, Singapore (SG)

(21) Appl. No.: 18/788,922

(22) Filed: Jul. 30, 2024

(51) Int. Cl. H04N 23/60; G06F 1/16; G06F 3/16; G06T 17/00; H04N 13/239; H04N 23/611

(52) U.S. Cl. CPC H04N 23/64; G06F 1/163; G06T 17/00; H04N 13/239; H04N 23/611; G06F 3/167

(57) ABSTRACT

Methods and systems for obtaining information regarding a scene using a display free body wearable computing device are disclosed. The method may include identifying a scope of interest in the scene as indicated by a user of the display free body wearable computing device via one or more user inputs. The method may also include obtaining an image capture plan to obtain a set of images depicting the scope of interest. The image capture plan may include, for example, a number of images, locations and fields of views of images of the set of images, a motion plan, and/or any other information. The method may also include actively guiding movement of the user by providing sensory feedback while the user performs the image capture plan.

### FIELD

Embodiments disclosed herein relate generally to information acquisition. More particularly, embodiments disclosed herein relate to obtaining information regarding a scene using a display free body wearable computing device by guiding movement of a user of the display free body wearable computing device.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1A shows a diagram illustrating a display free body wearable computing device in accordance with an embodiment.

FIGS. 1B-1D show diagrams illustrating alternative views of the display free body wearable computing device in accordance with an embodiment.

FIG. 2 shows a diagram illustrating a system in accordance with an embodiment.

FIGS. 3A-3D show flow diagrams illustrating methods in accordance with an embodiment.

FIGS. 4A-4E show example diagrams illustrating activity that may occur during performance of methods in accordance with an embodiment.

FIG. 5 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for providing computer-implemented services using a display free body wearable computing device. The display free body wearable computing device may be configured to be worn on a user's head. When worn by the user, the display free body wearable computing device may provide computer-implemented services by interacting with the user.

The computer-implemented services may include obtaining information regarding a scene. The information may be used, for example, in generating a three-dimensional model. To obtain the information, the display free body wearable computing device may identify a scope of interest in the scene based on user input from the user and capture a set of images depicting portions of the scene.

To obtain the user input, the display free body wearable computing device may include sensors (e.g., cameras, a microphone array, etc.). The user input may include, for example, voice commands, recognizable gestures (e.g., pointing gestures, etc.), and/or any other input that may indicate interest in a portion of the scene. The display free body wearable computing device may identify a scope of interest in the scene based on the user input. The scope of interest may include, for example, an object present in the scene, all of the scene, and/or a portion of the scene.

When identified, the display free body wearable computing device may generate an image capture plan based on the scope of interest. The image capture plan may include obtaining a motion plan that, when performed by the user, enables the display free body wearable computing device to capture a set of images that meet criteria for generating a three-dimensional model with a desired level of quality.

To capture the set of images, the display free body wearable computing device may actively guide movement of the user based on the image capture plan by (i) monitoring movement of the user, (ii) comparing the movement of the user to the motion plan, (iii) capturing images while the user is performing the motion plan, (iv) comparing each image of the images to a quality standard, (v) providing sensory feedback to the user that indicates a change in the movement of the user, and/or performing any other actions.

Thus, embodiments disclosed herein may provide an improved method for obtaining information regarding a scene using a display free body wearable computing device by guiding user movement based on an image capture plan to obtain a set of images depicting portions of the scene. By doing so, the set of images may be used to provide computer-implemented services that may have a higher level of quality.

In an embodiment, a method for obtaining information regarding a scene using a display free body wearable computing device is provided. The method may include: (i) identifying a scope of interest in the scene as indicated by a user of the display free body wearable computing device; (ii) obtaining an image capture plan based on the scope of interest; and (iii) actively guiding movement of the user based on the image capture plan to obtain a set of images depicting portions of the scene.

Identifying the scope of the interest may include: (i) obtaining, using at least one camera of the display free body wearable computing device, a first image depicting: (a) a first portion of the scene, and (b) a gesture introduced into the scene by the user; and (ii) identifying, based on the gesture and the first portion of the scene, the scope of the interest in the scene.

In an instance of the obtaining of the first image where the gesture may indicate interest of the user in an object present in the scene: the scope of the interest is limited to the object.

In an instance of the obtaining of the first image where the gesture may indicate general interest: the scope of the interest is all of the scene.

Obtaining the image capture plan may include: (i) identifying, based on the scope of the interest, a number of images usable to generate a three-dimensional model having a desired level of quality; and (ii) for each image of the number of images, identifying a location and field of view for obtaining the respective image based on the three-dimensional model having the desired level of quality.

Obtaining the image capture plan may further include: obtaining, based on the number of images, the locations, and the fields of view, a motion plan that, when performed by the user, enables a set of images to be captured using the at least one camera that allow for the three-dimensional model having the desired level of quality to be generated.

Actively guiding the user may include: (i) monitoring movement of the user; (ii) comparing the movement of the user to a motion plan indicated by the image capture plan; and (iii) in an instance of the comparing where the movement of the user diverges from the motion plan: (a) providing, to the user, sensory feedback that indicates a change in the movement of the user, the change being adapted to conform the movement of the user to the motion plan.

The sensory feedback may include spatial audio adapted to focus attention of the user on the scope of interest.

The sensory feedback may include audio queues that convey the change in the movement to the user.

Actively guiding the user may include: as the set of the images are obtained: (i) comparing each image of the set of images to a quality standard; (ii) in an instance of the comparing where an image of the set of images does not meet the quality standard: (a) discarding the image of the images; (b) providing, to the user, second sensory feedback that indicates a change in the movement of the user, the change being adapted to enable obtaining of a replacement image for the image of the images.

The method may further include providing computer-implemented services using the set of images.

Providing the computer-implemented services may include: (i) generating a three-dimensional model using the set of images; (ii) obtaining an insight using the three-dimensional model; and (iii) using the insight to convey enhanced information regarding the scene to the user.

The display free body wearable computing device may include: (i) an integrated sensing and interaction component adapted to: (a) be positioned symmetrically on two portions of a user's head, (b) be positioned between ears and eyes of the user, and (c) capture a stereo image of at least a portion of a scene present in a field of view of the user; (ii) an integrated computing, powering, and securing portion; and (iii) an adjustment member adapted to position the integrated sensing and interaction component with respect to the integrated computing, powering, and securing portion.

The integrated sensing and interaction component may include: (i) a pair of cameras; (ii) speakers; (iii) a microphone array; and (iv) a touch pad.

The integrated sensing and interaction component may be adapted to: (i) obtain the stereo image from the pair of cameras; (ii) at least partially process the stereo image to obtain an image processing result; (iii) identify an action to be performed based, at least in part, on the image processing result and a derived result from a remote entity, the derived result being based, at least in part, on the stereo image and/or the image processing result; and (iv) use at least the speakers to perform the action.

The pair of cameras may comprise lenses configured to: (i) establish a camera line of sight that is parallel to a line of sight of the user; and (ii) establish a camera field of view that comprises the field of view of the user.

The stereo image may include a pair of images of the scene, each of the images being captured at different angles and/or positions with respect to the scene by the pair of cameras.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

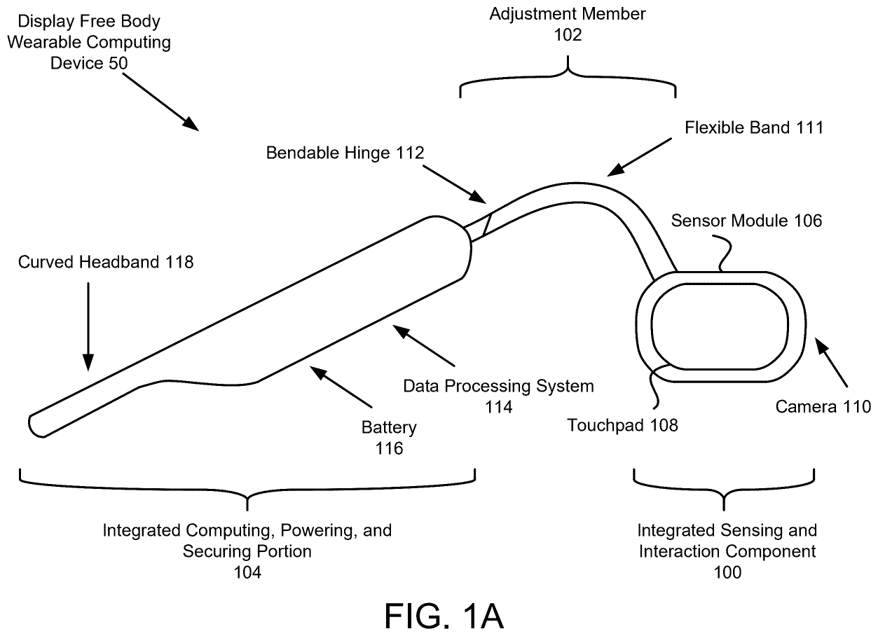

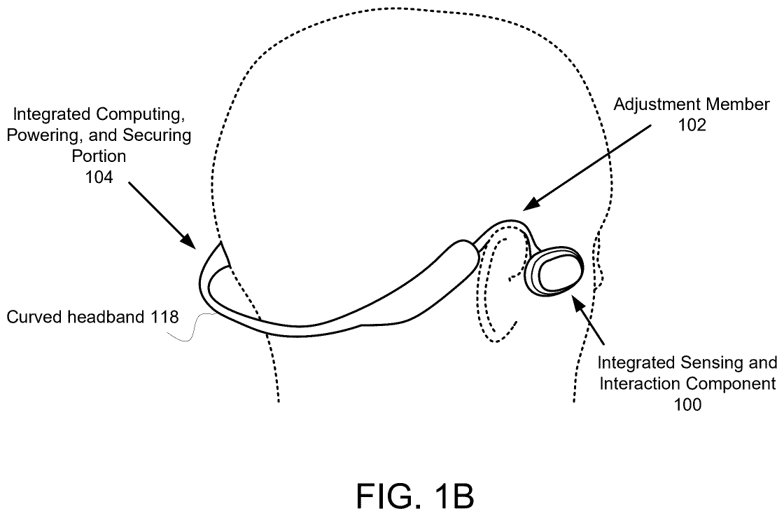

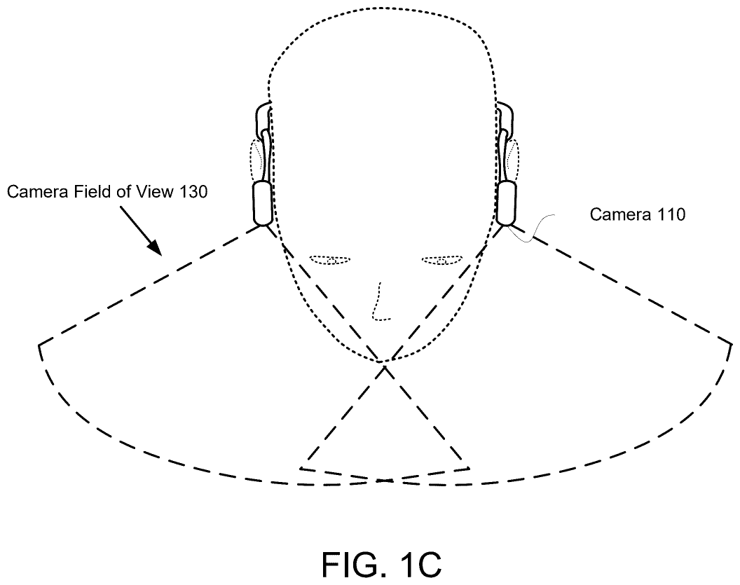

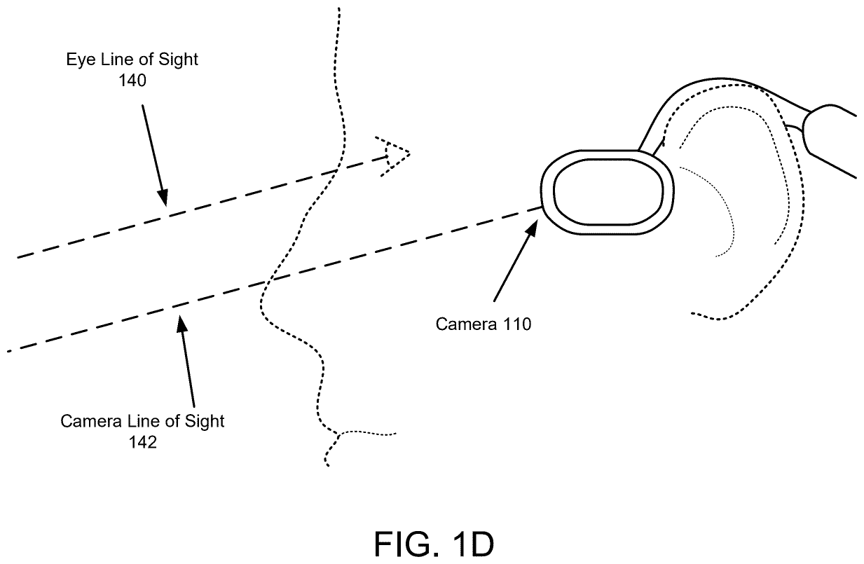

Turning to FIG. 1A, various types of computing devices may provide computer implemented services. The various types of computing devices may include, for example, desktop computers, laptop computers, cell phones, and/or other types of computing devices.

Such computing devices may provide any number and types of computer-implemented services (e.g., to a user of the computing device and/or devices operably connected to the computing device). The computer-implemented services may include, for example, data acquisition services, communication services, and/or other types of services that may be relevant to user and/or other devices.

However, the ability to provide such services may be limited based on the information available to the computing devices. For example, desktop computer may be positioned under a desk, or in other locations. Consequently, the desktop computer may have a very limited capability to gather information regarding the environment in which it resides.

Accordingly, due to the limited information, the types and quality of computer implemented services may be limited. Returning to the desktop computer example, such desktop computers may lack native ability to capture images and/or audio of scenes that are relevant to a user of the desktop computer. Thus, the desktop computer may lack the ability to provide some types of services that are relevant to a user.

In general, embodiments disclosed herein relate to systems, methods, and devices for providing computer implemented services that are of relevance to users. To provide the computer implemented services, a display free body wearable computing device may be utilized. For example, display free body wearable computing device 50 may be adapted to be worn by a user. When worn by a user, display free body wearable computing device 50 may be able to gather information that is more relevant to users for use in providing computer-implemented services.

The computer-implemented services may include, for example, generating a three-dimensional model based on a set of set of images captured by display free body wearable computing device 50 to convey enhanced information regarding the scene to the user. To do so, a scope of interest in the scene may be identified based on user input (e.g., a gesture, voice command, etc.) that may indicate interest of the user in an object present in the scene, all of the scene, and/or any other portion of the scene.

To capture the set of images, display free body wearable computing device 50 may obtain an image capture plan based on the scope of interest. The image capture plan may consider: (a) a number of images, (b) locations and/or fields of view of a camera of display free body wearable computing device 50, and/or any other information usable to usable to generate the three-dimensional model of a desired level of quality.

Based on the image capture plan, display free body wearable computing device 50 may actively guide the user to move around the scene while a camera of the display free body wearable computing device captures images from different angles and/or positions with respect to the scope of interest in the scene.

To actively guide the user, display free body wearable computing device 50 may (i) monitor movement of the user, (ii) compare the movement of the user to a motion plan, (iii) compare each image of the captured images to a quality standard, (iv) provide sensory feedback to the user that indicates a change in the movement of the user, and/or perform any other actions. The sensory feedback may include, for example, audio cues (e.g., voice prompts, sounds, etc.) adapted to conform movement of the user when movement of the user diverges from the motion plan and/or enable obtaining a replacement image when an image captured does not meet a quality standard of the image capture plan.

By capturing the set of images based on the image capture plan, display free body wearable computing device 50 may use the set of images to provide computer-implemented services that may have a higher quality and/or relevance to the user.

To provide the computer-implemented services to the user of display free body wearable computing device 50, display free body wearable computing device 50 may include: (i) integrated sensing and interaction component 100, (ii) adjustment member 102, and (iii) integrated computing, powering, and securing portion 104. Each of these components is discussed below.

Integrated sensing and interaction component 100 may provide input/output services to the user. To do so, integrated sensing and interaction component 100 may host sensors module 106, touchpad 108, camera 110, and/or any other components. To host the components, integrated sensing and interaction component 100 may include a pair of enclosures (e.g., 3-dimensional bubble-shaped housings that may be at least partially transparent) adapted to be positioned symmetrically on both sides of the user's head, between ears and eyes of the user (e.g., proximate to temples of the user). When worn, integrated sensing and interaction component 100 may operate, for example, without covering the user's ear and extending past the user's eyes. By being positioned as such, the body wearable computing device may be worn and used to interact with the user without obstructing facial features (e.g., eyes, ears, etc.) of the user.

Integrated sensing and interaction component 100 may obtain inputs from any number of sensors to identify actions to be performed. For example, integrated sensing and interaction component 100 may obtain guidance image using camera 110 and at least partially process the guidance image to obtain an image processing result. The guidance image may depict a portion of the scene and a portion of the user (e.g., one or more of the user's hands) of display free body wearable computing device 50. Integrated sensing and interaction component 100 may identify a recognizable gesture (e.g., a pointing gesture, framing gesture, etc.) from the guidance image that may trigger an action set for capturing an image. Integrated sensing and interaction component 100 may also obtain and use audio inputs (e.g., voice commands) for use in identifying actions sets for capturing an image, individually and/or cooperatively with visual inputs (e.g., the guidance image).

For example, consider a scenario in which a user raises a hand to point at car while issuing a voice command to take a picture. Integrated sensing and interaction component 100 may identify the user's hand as a pointing gesture and/or identify the voice command issued by the user. Integrated sensing and interaction component 100 and/or any other entities (e.g., data processing system 114, remote entities, etc.) may subsequently identify an action set based on the gesture and/or the voice command. The action set may include, for example, audio instructions using speakers of integrated sensing and interaction component 100 to direct the user to remove the user's hand from a field of view while retaining the car in the field of view, activating image sensors of camera 110 to capture a stereo image, combining the stereo image, and/or any other actions.

Touchpad 108 may be used to receive tactile input. For example, a user may provide input by using one or more fingers to touch, press, any/or perform any other actions using touchpad 108. The input may be used, for example, to trigger actions, provide information to the display free body wearable computing device for use in providing computer-implemented services, and/or any other use cases. To improve ease of use, touchpad 108 may be affixed to a lateral side of integrated sensing and interaction component 100 away from the user's head when worn. Touchpad 108 may be included on either or both enclosures of integrated sensing and interaction component 100.

Sensor module 106 may provide at least a portion of the input/output services provided by integrated sensing and interaction component 100. To do so, sensors module 106 may include any number and/or type of sensors. For example, sensors module 106 may include speakers and a microphone array. The microphone array of sensor module may obtain, for example, a voice command from the user. Integrated sensing and interaction component 100 may process the voice command to trigger an action set to capture an image of the scene. Sensor module 106 may also provide audio output (e.g., via the speakers). The audio output may include, for example, spatial audio cues (e.g., sounds, beeps, etc.) to indicate a motion plan, instructions (e.g., verbal instructions) to direct movement of a portion of the user while capturing an image, information regarding a status of the images captured, and/or any other information.

Sensor module 106 may also include any number and/or types of motion sensors (e.g., accelerometers, gyroscopes, etc.). The motion sensors may obtain sensor data that may be used to (i) identify a positioning, movement, and/or orientation of the user while using display free body wearable computing device 50, (ii) provide a directionality of spatial audio feedback, and/or any provide information for any other actions.

Camera 110 may capture images. The images captured by camera 110 may include stereo images of at least a portion of a scene present in a field of view of the user. The stereo images may include a pair of images of the scene, each of the images being captured at different angle and/or positions (e.g., different viewpoints) with respect to the scene by camera 110.

To do so, camera 110 may include a pair of cameras that may each be positioned inside an enclosure of the pair of enclosures of integrated sensing and interaction component 100 on both sides of the user's head between eyes and ears of the user. Furthermore, camera 110 may be pointed in a direction generally aligned with a direction that the user's eyes may be pointed. By being positioned as such, camera 110 may be configured to establish a camera line of sight that is parallel to a line of sight of the user, and a camera field of view that include the field of view of the user. Refer to FIGS. 1C-1D for additional details regarding the camera field of view and the camera line of sight relative to the user.

Camera 110 may configure image capturing settings (e.g., focus, zoom, etc.) based on information obtained by integrated sensing and interaction component 100 and/or any other components of display free body wearable computing device 50 (e.g., data processing system 114).

Adjustment member 102 may at least partially secure display free body wearable computing device 50 to the user's head and be adapted to position integrated sensing and interaction component 100 with respect to integrated computing, powering, and securing portion 104. To do so, adjustment member may include flexible band 111 and bendable hinge 112.

Flexible band 111 may be configured in a shape (e.g., a curved shape) that may enable adjustment member 102 to rest on an ear of the user while display free body wearable computing device 50 is used by the user. Furthermore, flexible band 111 (e.g., the shape of flexible band 111) may be modified (e.g., via bending) to improve comfort and/or fit of display free body wearable computing device 50 while used by the user.

Bendable hinge 112 may enable repositioning of integrated sensing and interaction component 100 with respect to integrated computing, powering, and securing portion 104. For example, when bendable hinge 112 is in a first state (e.g., not bent), integrated computing, powering, and securing portion 104 may be configured to be positioned around the back of the user's head while integrated sensing and interaction component 100 is positioned between ears and eyes of the user. Alternatively, when bendable hinge 112 is in a second state (e.g., bent at a certain angle), integrated computing, powering, and securing portion 104 may be configured to be positioned around the top of the user's head while integrated sensing and interaction component 100 is positioned between ears and eyes of the user.

Integrated computing, power, and securing portion 104 may provide at least a portion of the computer-implemented services and may at least partially secure display free body wearable computing device 50 to the user. To do so, integrated computing, powering, and securing portion 104 may include an enclosure that includes: (i) data processing system 114, (ii) battery 116, and (iii) curved headband 118.

Data processing system 114 may provide computer-implemented services based on inputs (e.g., stereo images, audio inputs, etc.) obtained from integrated sensing and interaction component 100. To do so, data processing system 114 may host any quantity of hardware resources that may include, for example, a processor operably coupled to memory, storage, and/or other hardware components (e.g., sensors of integrated sensing and interaction component 100). Data processing system 114 may facilitate performance of actions requested by a user of display free body wearable computing device 50 (e.g., independently and/or cooperatively with remote entities that may provide a second portion of computer-implemented services).

Using the hosted hardware resources and/or applications supported by the hardware resources, data processing system 114 may provide services relevant to images, audio, text, decision making, and/or any other capabilities. For example, data processing system 114 may perform operations relevant to the service and/or data processing system 114 may communicate with remote entities using a network stack hosted by hardware resources of data processing system 114.

To provide services relevant to images (e.g., pictures, video, etc.), data processing system 114 may obtain image data from one or more cameras of camera 110. The image data may be used to identify user inputs (e.g., hand gestures) that may indicate requests for actions to be performed by the body wearable computing device. Data processing system 114 may subsequently make decisions to handle the requests based on the user input. Additionally, data processing system 114 may perform image stitching using a stereo image of the image data to obtain a unified image of a portion of a scene present in a field of view of the user. Data processing system 114 may process and/or perform actions based on derived information from the unified image.

For example, based on a user gesture indicating a request to scan an object in the scene (e.g., for generation of a three-dimensional model of the object) and a first image of the object obtained from integrated sensing and interaction component 100, data processing system 114 may obtain an image capture plan. To do so, data processing system 114 may (i) identify a number and/or quality of images required to generate a three-dimensional model having a desired level of quality, locations and fields of view for obtaining a set of images, (ii) obtain a motion plan for the user to perform, and/or perform any other actions. Data processing system 114 may subsequently transmit at least portions of the image capture plan to integrated sensing and interaction component 100 for communication to the user.

To handle the requests based on the user inputs for decision making, data processing system 114 may utilize hardware and/or software adapted to process the user inputs. For example, data processing system 114 may use a tactile input handling application to make decisions (e.g., perform an action set, communicate information, etc.) based on tactile input received from touchpad 108.

Additionally, data processing system 114 may perform services based on audio input received from a microphone array of sensor module 106 that may include, for example, transcription, speaker segmentation, and/or any other service. To do so, data processing system 114 may, for example, host applications adapted to interpret conversations, recognize speech, convert speech to text, and/or perform any other operations. Data processing system 114 may similarly make decisions based on information obtained from the audio input.

To communicate results of the services to the user of the body wearable computing device, data processing system 114 may send information to be output from speakers of sensor module 106. To do so, data processing system 114 may utilize hardware and/or software to transmit the information to the speakers. For example, an application may convert text results obtained from the audio and/or image services, as discussed above, to an audio output format that may be communicated to the user.

Consider a scenario in which a first image includes the user's hands and an object in the scene in which the user is present. Data processing system 114 and/or integrated sensing and interaction component 100 may recognize hand gestures performed by the user's hands that may indicate a request for display free body wearable computing device 50 to capture images and/or scan the object for use in generating a three-dimensional model of the object. Data processing system 114 may subsequently communicate the image and/or information from the image to any number and/or type of remote entities (e.g., cloud services, remote artificial intelligence platforms, etc.) that may provide additional services that may provide requested information/results to data processing system 114. Data processing system 114 may then provide instructions to integrated sensing and interaction component 100 to dictate (e.g., using speakers) the requested information. Once the images of the object have been captured, data processing system 114 may obtain the images, at least partially process the images, communicate the images to the remote entities, and/or perform any other actions.

Battery 116 may supply electrical power to data processing system 114, components of integrated sensing and interaction component 100, and/or any other entities. To do so, battery 116 may obtain and/or store electrical power provisioned by an external power source. The electrical power may subsequently be provided to components of display free body wearable computing device 50 that may request the electrical power for operation.

Curved headband 118 may connect two portions of the body wearable computing device. For example, curved headband may be configured in a curved shape and be adapted to connect a first side of display free body wearable computing device 50 (e.g., including a first portion of integrated sensing and interaction component 100, adjustment member 102, etc.) that may be positioned on the first side of the user's head to a second side of display free body wearable computing device 50 that may be positioned on the second side of the user's head.

While illustrated in FIG. 1A with a limited number of specific components, a system may include additional, fewer, and/or different components without departing from embodiments disclosed herein.

Thus, as shown in FIG. 1A, display free body wearable computing device 50 may provide computer-implemented services to a user using components adapted to obtain information regarding a scene desired by the user.

Turning to FIG. 1B, an alternate view of display free body wearable computing device 50 in accordance with an embodiment is shown.

In FIG. 1B, display free body wearable computing device 50 may be illustrated while worn by a user (drawn in short-dashed outline). As shown in FIG. 1B, a portion of integrated sensing and interaction component 100 of display free body wearable computing device 50 is positioned on a first side of the user's head between an eye and an ear of the user while a portion of adjustment member 102 rests on the ear of the user. While not shown, it may be appreciated that a second portion of integrated sensing and interaction component 100 and a second portion of adjustment member 102 may be similarly positioned on a second side of the user's head.

Integrated computing, powering, and securing portion 104 and curved headband 118 of integrated computing, powering, and securing portion 104 may connect the first portions and second portions of adjustment member 102 and integrated sensing and interaction component 100. To do so, curved headband 118 may wrap around the back of the user's head, as shown, while adjustment member 102 is in a first configuration (e.g., not bent). While not shown, it may be appreciated that curved headband 118 and integrated computing, powering, and securing portion 104 may be positioned around the top of the user's head and/or any other position when adjustment member 102 is in a second configuration.

Turning to FIG. 1C, a second alternate view of display free body wearable computing device 50 in accordance with an embodiment is shown. The second alternate view of display free body wearable computing device 50 may include a top-down view of display free body wearable computing device 50 while worn by a user (drawn in short-dashed outline) and may illustrate a camera field of view established by camera 110 (drawn in long-dashed outline).

Camera 110 of integrated sensing and interaction component 100 may, as discussed above, include a pair of cameras positioned on both sides of the user's head between eyes and ears of the user and may be pointed in a direction generally aligned with a direction that the user is facing. Each camera of the pair of cameras may include lens and a sensor that may be configured to establish a portion of camera field of view 130. Camera field of view 130 may include an angular measurement that may indicate a viewable area that may be captured by the camera.

Camera field of view 130 may be established based on the lens (e.g., a focal length of the lens) and/or the sensor (e.g., a size of the sensor) of camera 110. Each camera of the pair of cameras of camera 110 may establish a portion of camera field of view 130 that may each capture a portion of a scene at different angles and/or positions with respect to the scene by the pair of cameras.

For example, consider a scenario in which camera field of view 130 is configured by camera 110 to be 120 degrees of horizontal view. Each camera of the pair of cameras of display free body wearable computing device 50 may capture an image based on the 120 degrees of the scene present in a field of view of the user. When aggregated (e.g., used together), a field of view of the images exceed a field of field of the user. The field of view of the user may include, for example, 120 degrees of viewable area based on binocular vision (e.g., a single image perceived from a pair of images view by a pair of eyes) of the user. The pair of cameras of camera 110 may similarly capture a stereo image that may include a pair of images of the portion of the scene present in the field of view of the user at the different angles and/or positions.

The stereo image may be processed (e.g., via image stitching, aggregation, etc.) by integrated sensing and interaction component 100, data processing system 114, and/or any other entities to generate a resulting image that may include at least the portion of the scene present in the field of view of the user (e.g., a greater field of view when compared to the user's field of view based on the user's binocular vision). The resulting image may subsequently provide information (e.g., additional information that the user may not obtain based on a field of view of the user's eyes) relevant to providing computer-implemented services to the user.

Thus, as shown in FIG. 1C, camera 110 of display free body wearable computing device 50 may be adapted to capture images of at least a portion of the scene present in a user's field of view. The images may provide visual information usable to perform desired actions by display free body wearable computing device 50 for the user.

Turning to FIG. 1D, a third alternate view of display free body wearable computing device 50 in accordance with an embodiment is shown. The third alternate view of display free body wearable computing device 50 may include a side view of display free body wearable computing device 50 while worn by a user and may illustrate a camera line of sight established by camera 110.

Camera 110 may, as discussed above, include a pair of cameras positioned on both sides of the user's head between eyes and ears of the user and may be pointed in a direction generally aligned with a direction that the user is facing. Each camera of the pair of cameras may include lens and a sensor that may be configured to establish camera line of sight 142 that may be parallel to eye line of sight 140 of the user.

Camera line of sight 142 may enable camera 110 to capture images based on a vertical field of view that may be generally aligned with a vertical field of view of the user's eyes. The vertical field of view may be established, for example, by configuring cameras 110 (e.g., in a portrait orientation) to capture a vertical field of view that may include a vertical field of view of the user's eyes. By doing so, camera 110 may capture images of arm/hand movements and/or gestures when performed by the user.

Thus, as shown in FIG. 1D, cameras of display free body wearable computing device 50 may be adapted to capture images that may enable a user to interact with display free body wearable computing device 50 based on the user's line of sight.

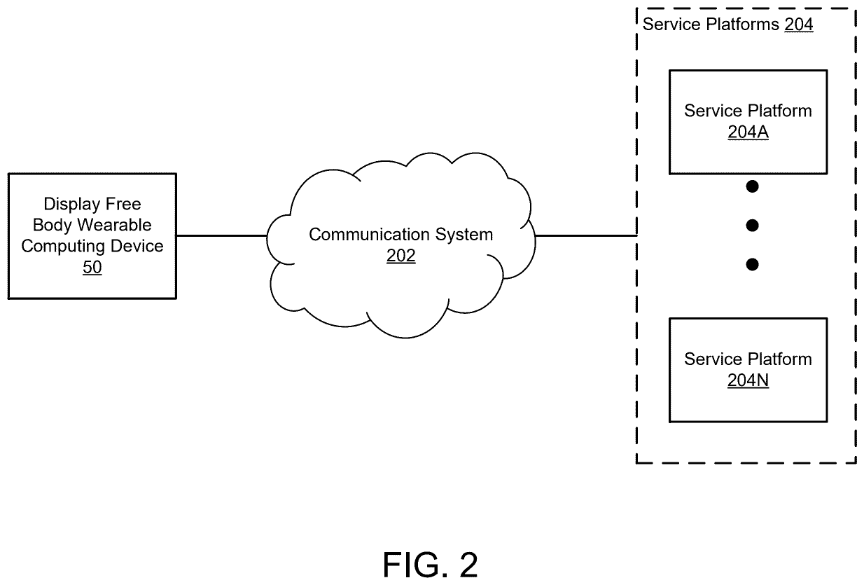

Turning to FIG. 2, a block diagram in accordance with an embodiment is shown. The block diagram may illustrate a system used in providing computing-implemented services by the display free body wearable computing device.

Display free body wearable computing device 50 may, as previously discussed, provide computer-implemented services to a user. While providing the computer-implemented services, display free body wearable computing device 50 may interact with service platforms 204 to obtain information relevant to the computer-implemented services provided to the user.

Service platforms 204 may, as discussed above, provide remote computing services. Service platforms 204 may include any number and/or type of service platforms that may individually and/or cooperatively perform services requested by display free body wearable computing device 50. Service platforms 204 may include, for example, cloud services (e.g., image storage, speech-to-text, large language model, etc.), artificial intelligence platforms (e.g., generative artificial intelligence), and/or any other remote service platforms. Service platforms 204 may provide information based at least in part on input obtained from display free body wearable computing device 50.

Consider a scenario in which a user of display free body wearable computing device 50 desires to generate a three-dimensional (3D) interactive model of a room that the user is present. Once a request for the 3D interactive model is identified, display free body wearable computing device 50 may: (i) provide instruction to the user (e.g., to move around the room), (ii) capture images using the camera at a certain frequency (e.g., while the user is moving around the room), and/or perform any other actions. Display free body wearable computing device 50 may provide the captured images along with metadata regarding each of the captured images to a second service platform (e.g., 204B) of service platforms 204. Using image data provided by display free body wearable computing device 50, service platform 204B may perform, for example, 3D rendering service, video editing service, video storage services, and/or any other services to generate the 3D interactive model desired by the user. Display free body wearable computing device 50 may subsequently communicate a status (e.g., completion, instructions for access, etc.) of the desired 3D interactive model to the user.

Consider a second scenario in which a user, while wearing display free body wearable computing device 50, may be looking at a bird perched on a tree in a forest. Display free body wearable computing device 50 may obtain a request (e.g., via a voice command captured by a microphone array of display free body wearable computing device 50, a gesture captured by cameras of from display free body wearable computing device 50, etc.) from the user indicating a desire for a picture of the bird. Display free body wearable computing device 50 may: (i) obtain data that may include an image of the scene, (ii) pre-process the data (e.g., focus the image on the bird, stitch images from a plurality of images captured by cameras of display free body wearable computing device 50, etc.) to obtain a unified image, (iii) communicate the unified image to a service platform (e.g., 204A) of service platforms 204, and/or perform any other actions. Service platform 204A may perform, for example, object recognition services, information search services, and/or any other services to capture the desired image based on the unified image provided by display free body wearable computing device 50. Service platform 204A and/or a second service platform (e.g., service platform 204B) may store the desired image in an image storage service for subsequent retrieval by a user of display free body wearable computing device 50.

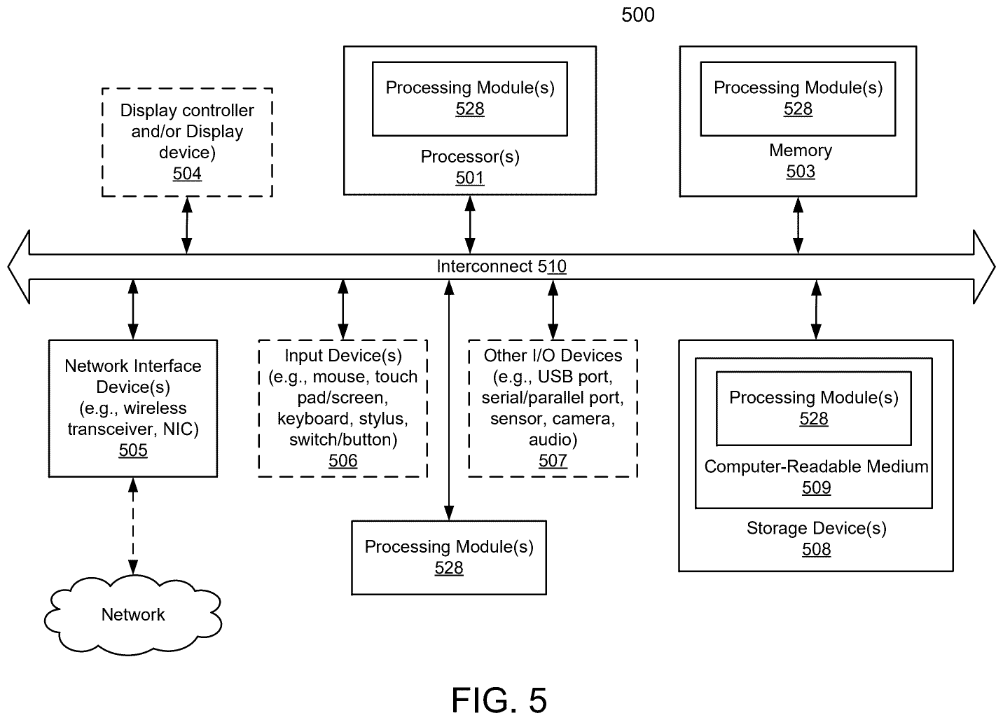

Communication system 202 may allow any of display free body wearable computing device 50 and service platforms 204 to communicate with one another (and/or with other devices not illustrated in FIG. 2). To provide its functionality, communication system 202 may be implemented with one or more wired and/or wireless networks. Any of these networks may be a private network (e.g., the “Network” shown in FIG. 5), a public network, a virtual network (e.g., a virtual private network), and/or may include the Internet. For example, display free body wearable computing device 50 may be operably connected to service platforms 204 via the Internet, a private network, etc. Display free body wearable computing device 50 and service platforms 204 may be adapted to perform one or more protocols for communicating via communication system 202.

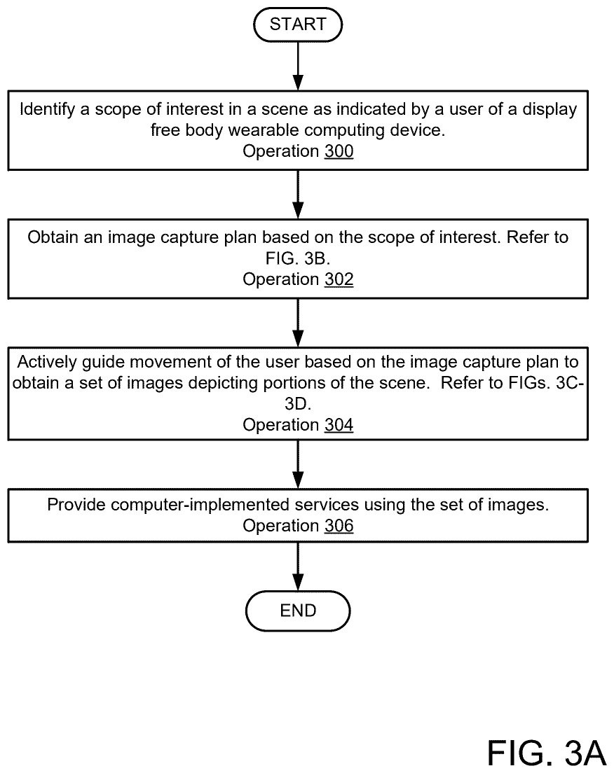

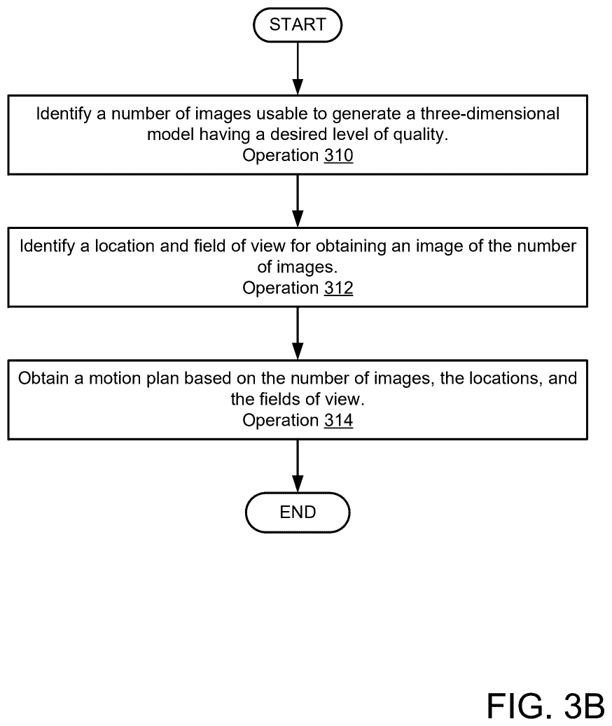

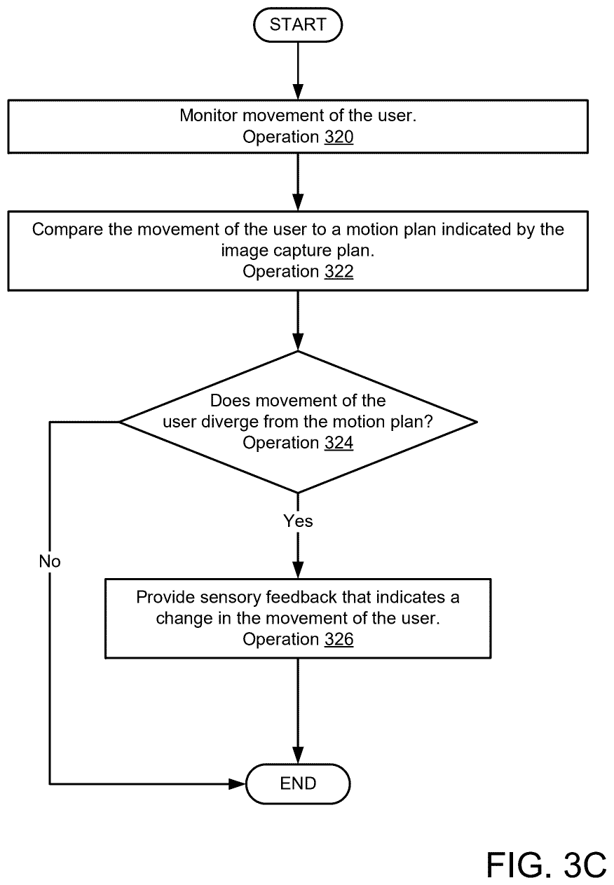

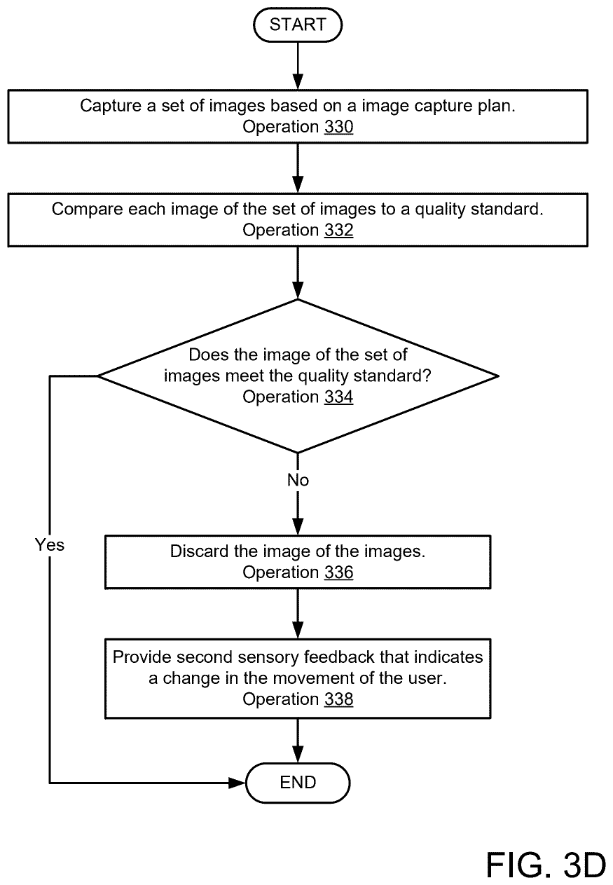

As discussed above, the components of FIG. 1A may perform various methods to obtain information regarding a scene using a display free body wearable computing device. FIGS. 3A-3D illustrate methods that may be performed by the components of the system of FIG. 1A. In the diagrams discussed below and shown in FIGS. 3A-3D, any of the operations may be repeated, performed in different orders, and/or performed in parallel with or in a partially overlapping in time manner with other operations.

Turning to FIG. 3A, a first flow diagram illustrating a method of obtaining a set of images depicting portions of the scene in accordance with an embodiment is shown. The method may be performed, for example, by any of the components of the system of FIG. 1A, and/or other components not shown therein.

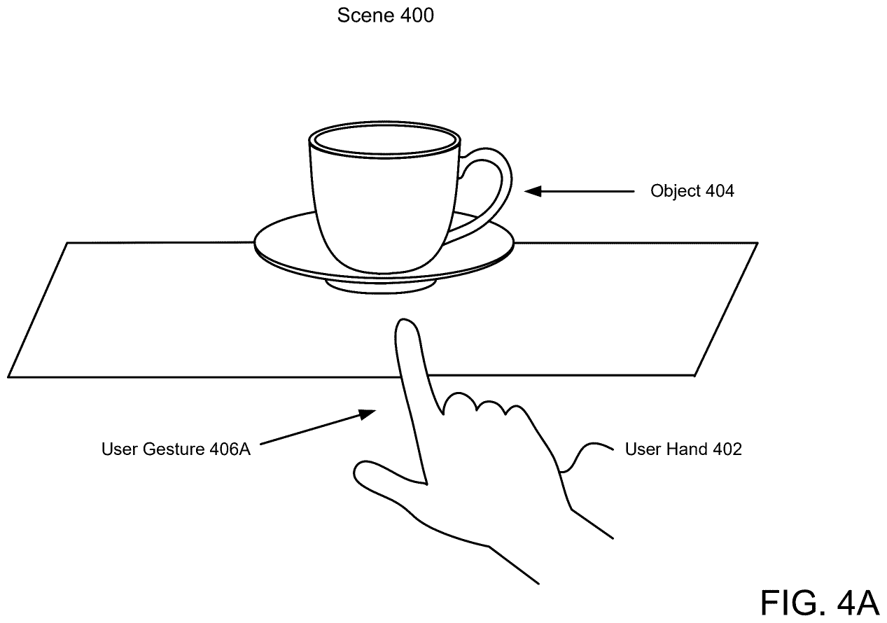

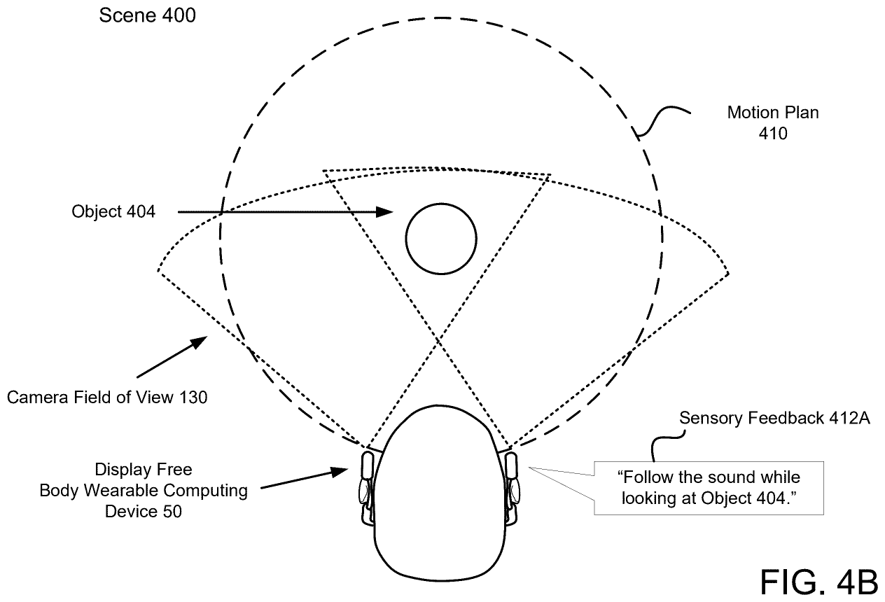

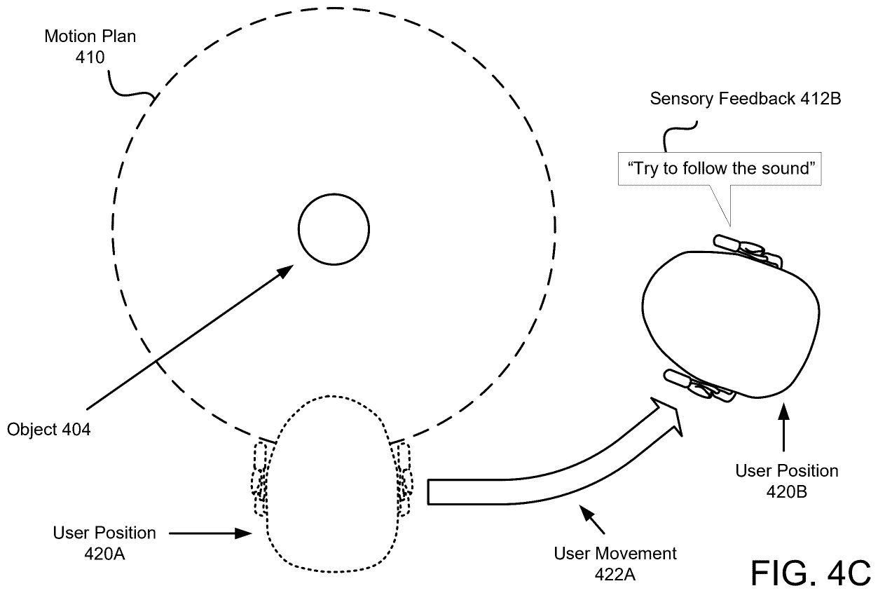

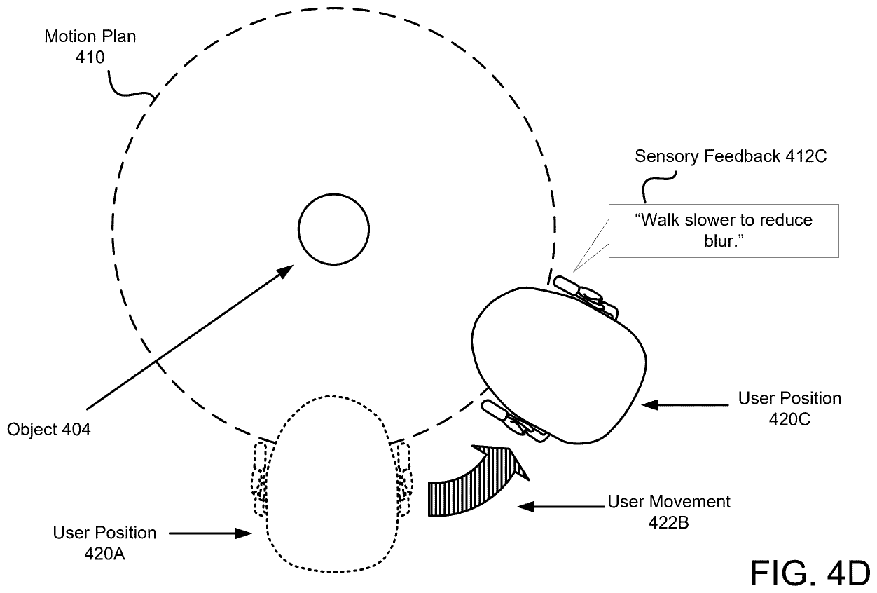

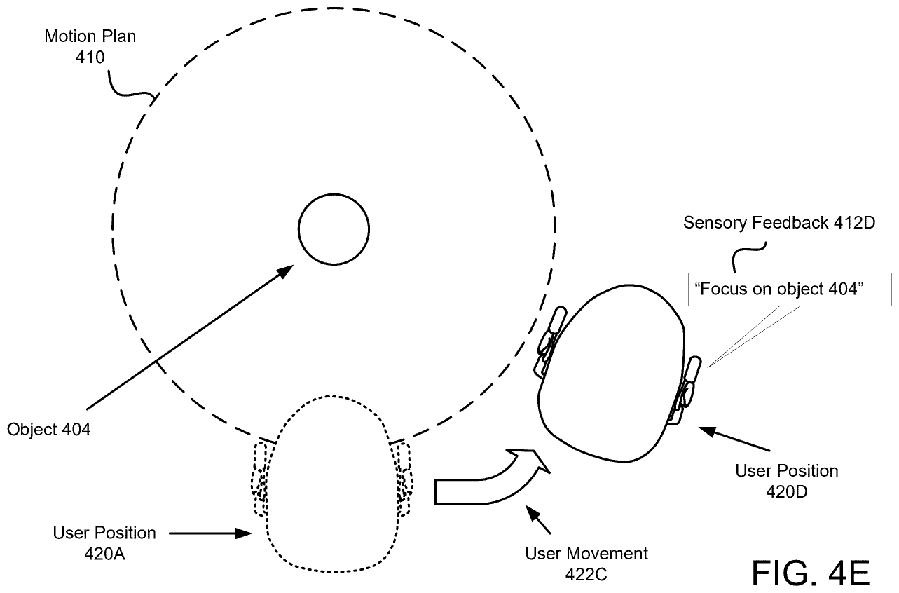

At operation 300, a scope of interest in a scene may be identified as indicated by a user of a display free body wearable computing device. The scope of interest may be identified by: (i) obtaining, using at least one sensor (e.g., a camera, microphone array, etc.) of display free body wearable computing device 50, user input (e.g., a hand gesture, voice command, etc.) indicating interest in a portion of the scene, (ii) interpreting the user input to identify an object and/or a portion of the scene to be of interest to the user, (iii) obtaining a guidance image of at least the portion of the scene, (iv) identifying, based on the guidance image and the user input, the scope of interest (e.g., an object present in the scene, all of the scene, etc.) in the scene, (v) performing object segmentation to identifying an object present in the scene, and/or any other processes. Refer to FIG. 4A for additional details.

At operation 302, an image capture plan may be obtained based on the scope of interest. The image capture plan may be obtained by: (i) identifying, based on the scope of interest, a number of images usable to generate a three-dimensional model having a desired level of quality, (ii) identifying a location and field of view for obtaining each image of the number of images, (iii) obtaining a motion plan that enables a set of images to be captured, and/or other any other processes. Refer to FIG. 3B for additional details.

At operation 304, movement of the user may be actively guided based on the image capture plan to obtain the set of images depicting portions of the scene. Movement of the user may be actively guided by: (i) analyzing images captured while the user is following a motion plan of the image capture plan, (ii) monitoring movement of the user, (iii) comparing the movement of the user to the motion plan, (iv) comparing each image of the images captured to a quality standard (v) providing sensory feedback, based on the movement of the user and/or a quality of an image of the images, to indicate a change to the movement of the user, and/or any other processes. Refer to FIG. 3C-3D for additional details.

At operation 306, computer-implemented services may be provided using the set of images. The computer-implemented services may be provided by: (i) processing images of the set of images (e.g., editing, selecting, stitching, etc.), (ii) providing the set of images to data processing system 114 and/or remote entities, (iii) generating a three-dimensional model using the set of images, (iv) obtaining an insight using the three-dimensional model, (v) conveying enhanced information regarding the scene to the user using the insight, and/or any other processes.

The method may end following operation 306.

Using the method shown in FIG. 3A, a set of images depicting portions of a scene may be obtained that depict portions of the scene that the user may have conveyed interest. By doing so, display free body wearable computing device 50 may use the set of images to provide computer-implemented services (e.g., generate a three-dimensional model to convey enhanced information regarding the scene) to the user.

Turning to FIG. 3B, a second flow diagram illustrating a method of obtaining an image capture plan in accordance with an embodiment is shown. The method may be performed, for example, by any of the components of the system of FIG. 1A, and/or other components not shown therein.

At operation 310, a number of images usable to generate a three-dimensional model having a desired level of quality may be identified. The number of images may be identified by: (i) identifying the desired level of quality (e.g., a resolution, interactivity, etc.) of the three-dimensional model, (ii) obtaining a target number of images from a settings repository, (iii) analyzing a quality (e.g., size) of the scene and/or an object indicated by the scope of interest, and/or any other processes.

At operation 312, a location and field of view for obtaining an image of the number of images may be identified. The location and field of view may be identified by: (i) analyzing the scope of interest and/or a portion of the scene around the scope of interest, (ii) identifying features (e.g., corners, interest points, etc.) of the scope of interest, and/or any other processes.

At operation 314, a motion plan may be obtained based on the number of images, the location, and the fields of view. The motion plan may be obtained by: (i) aggregating the locations and fields of view for obtaining each respective image of a set of images, (ii) projecting a path that may include each location of the locations, and/or any other processes. Refer to FIG. 4A for additional details.

The operation may end following operation 314.

Using the method shown in FIG. 3B, a motion plan based on an image capture plan may be obtained by display free body wearable computing device 50. When performed by the user, the motion plan may enable a set of images to be captured using at least one camera of display free body wearable computing device 50 that may allow for a three-dimensional model to be generated.

Turning to FIG. 3C, a third flow diagram illustrating a method of actively guiding movement of the user in accordance with an embodiment is shown. The method may be performed, for example, by any of the components of the system of FIG. 1A, and/or other components not shown therein.

At operation 320, movement of the user may be monitored. Movement of the user may be monitored by: (i) using any number and/or type of motion sensors (e.g., accelerometers, gyroscopes, etc.) of display free body wearable computing device 50, (ii) analyzing images captured by a camera while the user is moving, (iii) identifying features (e.g., landmarks) of the scope of interest and/or second portion of the scene relative to the scope of interest.

At operation 324, movement of the user may be compared to a motion plan indicated by the image capture plan. Movement of the user may be compared to the motion plan by: (i) identifying a position of the user relative to a path indicated by the motion plan, (ii) analyzing each image captured while the user is performing the motion plan, (iii) identifying a location and/or orientation of the scope of interest in each image captured, and/or any other processes.

At operation 324, a determination may be made regarding whether movement of the user diverges from the motion plan. The determination may be made by: (i) obtaining a result of the comparison between a position of the user and the path indicated by the motion plan, (ii) identifying whether movement of the user meets criteria (e.g., is within a distance threshold of the path), and/or performing any other actions. If the movement of the user diverges from motion plan (e.g., the determination is “Yes” at operation 324), then the method may proceed to operation 326. If the movement of the user does not diverge from the motion plan, the method may end following operation 324.

At operation 326, sensory feedback may be provided that indicates a change in the movement of the user. The sensory feedback may be provided by: (i) transmitting audio cues (e.g., sounds, beeps, etc.) to speakers of integrated sensing and interaction component 100, (ii) communicating a message (e.g., verbal instructions) via the speakers, (iii) adjusting a quality (e.g., direction, volume, tone, frequency, etc.) of the audio cues to convey a message, and/or performing any other actions.

The method may end following operation 326.

Using the method shown in FIG. 3C, movement of the user may be actively guided by providing sensory feedback based on movement of the user compared to a motion plan. By doing so, movement of the user may enable cameras of display free body wearable computing device 50 to capture a set of images that may have a higher likelihood of generating a three-dimensional model with a desired level of quality.

Turning to FIG. 3D, a fourth flow diagram illustrating a method of actively guiding movement of the user in accordance with an embodiment is shown. The method may be performed, for example, by any of the components of the system of FIG. 1A, and/or other components not shown therein.

At operation 330, a set of images may be captured based on an image capture plan. The set of images may be captured by: (i) activating camera sensors of a camera of display free body wearable computing device 50 based on the image capture plan (e.g., at certain positions, frequencies, etc.) to obtain an image, (ii) storing metadata of the image, (iii) at least partially processing the image, and/or performing any other actions.

At operation 332, each image of the set of images may be compared to a quality standard. Each image of the set of images may be compared to a quality standard by: (i) providing the image to a processing service hosted by integrated sensing and interaction component 100 and/or to data processing system 114, (ii) obtaining a group of quality standards, (iii) performing operations (e.g., overlapping) on the image relative to other images of the set of images, and/or any other processes.

At operation 334, a determination may be made regarding whether the image of the set of images meets the quality standard. The determination may be made by: (i) obtaining a result of the comparison between the image to the quality standard, (ii) identifying whether the image meets criteria (e.g., is within a quality threshold), and/or performing any other actions. If the image does not meet the quality standard (e.g., the determination is “No” at operation 334), then the method may end following operation 336. If the image does meet the quality standard, the method may end following operation 334.

At operation 336, the image of the set of images may be discarded. The image may be discarded by: (i) removing the image from the set of images, (ii) removing the image from storage of display free body wearable computing device 50, (iii) marking the image for exclusion from the set of images, and/or any other processes.

At operation 338, second sensory feedback may be provided that indicates a change in movement of the user. The second sensory feedback may be provided by (i) transmitting audio cues (e.g., sounds, beeps, etc.) to speakers of integrated sensing and interaction component 100, (ii) communicating a message (e.g., verbal instructions) via the speakers, (iii) adjusting a quality (e.g., direction, volume, tone, frequency, etc.) of the audio cues to convey a message, and/or performing any other actions. Refer to FIGS. 4D-4E for additional details.

Using the method shown in FIG. 3D, movement of the user may be actively guided by providing sensory feedback based on quality of images captured compared to a quality standard. By doing so, movement of the user may enable cameras of display free body wearable computing device 50 to capture replacement images of a set of images that may provide higher likelihood of generating a three-dimensional model with a desired level of quality.

Thus, using the method illustrated in FIGS. 3A-3D, a data processing system in accordance with an embodiment may be more likely to be able to obtain more relevant information to provide computer implemented services.

To further clarify details of the disclosed embodiments, FIGS. 4A-4E show example figures depicting activity that may occur while the methods shown in FIGS. 3A-3D are performed.

Turning to FIG. 4A, a first example diagram showing activity that may occur while an image is captured based on user input provided by a user of display free body wearable computing device 50 in accordance with an embodiment is shown. FIG. 4A may be shown, for example, from a perspective of camera 110 of display free body wearable computing device 50.

In FIG. 4A, the user of display free body wearable computing device 50 may be present in scene 400. Scene 400 may include a portion of a scene present in a field of view of display free body wearable computing device 50 (e.g., camera field of view 130) and/or a field of view of the user. Scene 400 may include objects that may be of interest to the user for purposes of scanning and/or capturing a set of images. For example, scene 400 may include object 404 (e.g., a cup and saucer as shown in FIG. 4A) and/or any other objects (not shown).

Camera 110 may obtain a guidance image that depicts scene 400 and user hand 402, as shown. To do so, camera 110 may, for example, (i) continuously capture images (e.g., real-time video), (ii) detect for the user's hands in the images, and/or perform any other actions. When the guidance image is captured, a gesture (e.g., user gesture 406A) may be identified from the guidance image. User gesture 406A may be identified as a pointing gesture, where an index finger of user hand 402 is pointing to object 404.

To identify a scope of interest, display free body wearable computing device 50 (e.g., integrated sensing and interaction component 100 and/or data processing system 114 of display free body wearable computing device 50) may perform any number and/or type of operations. For example, display free body wearable computing device 50 may (i) generate a projection of a point extending from the index finger of user hand 402, (ii) perform object segmentation and/or recognition services to identify objects in scene 400, (iii) obtain additional input (e.g., voice commands) from the user, and/or perform any other actions. A voice command may include, for example, verbal instructions from the user indicating a request to scan an object and/or all of the scene. By obtaining the user input, display free body wearable computing device 50 may identify object 404 as the object as the scope of interest in FIG. 4A.

Display free body wearable computing device 50 may subsequently obtain an image capture plan based on the scope of interest. When followed, the image capture plan may enable display free body wearable computing device 50 to capture images depicting the scope of interest for use in providing computer-implemented services. Refer to FIG. 4B for additional details regarding obtaining the image capture plan.

Turning to FIG. 4B a second example diagram showing activity that may occur while information regarding the scene is obtained based on a scope of interest indicated by a user of display free body wearable computing device 50 in accordance with an embodiment is shown.

As previously discussed in FIG. 4A, object 404 may have been identified as the scope of interest by display free body wearable computing device 50 based on user input from the user. Display free body wearable computing device 50 may provide computer-implemented services based on the scope of interest and/or the user input. The computer-implemented services may include, for example, generating a three-dimensional model using a set of images of object 404, obtaining insight using the three-dimensional model, using the insight to convey enhanced information regarding object 404 and/or a scene that object 404 is present, and/or any other services.

To do so, one or more cameras of display free body wearable computing device 50 may obtain information regarding object 404 and/or portions of scene 400 based camera field of view 130. The information may include, for example, features (e.g., corners, interest points, size, etc.) of object 404, features (landmarks, orientation, etc.) of scene 400, and/or any other information. Based on the information, display free body wearable computing device 50 may obtain an image capture plan.

To obtain the image capture plan, display free body wearable computing device 50 may identify a number of images usable to generate the three-dimensional model. For example, the number of images may be identified by: (i) identifying the desired level of quality (e.g., a resolution, interactivity, etc.) of the three-dimensional model, (ii) obtaining a target number of images from a settings repository, and/or performing any other actions. The number of images may include, for example, criteria and/or thresholds for images captured.

For each image of the images, display free body wearable computing device 50 may identify a location and field of view for capturing the respective image. To do so, display free body wearable computing device 50 may: (i) derive the locations and fields of view from a first image of scene 400, (ii) compute the locations and fields of view based on the number of images, (iii) utilize a predetermined algorithm, and/or perform any other actions.

Based on the number of images, the locations, and the fields of view. display free body wearable computing device 50 may obtain motion plan 410 (shown in long-dashed lines). Motion plan 410 may include a path that transverses each location of the identified locations. When performed by the user, motion plan 410 may enable display free body wearable computing device 50 to capture a set of images that allow for the three-dimensional model to be generated with the desired level of quality.

Motion plan 410 may be provided to the user of display free body wearable computing device 50 via a spatial audio path and/or any other feedback to the user. For example, in FIG. 4B, display free body wearable computing device 50 may transmit a sound (e.g., a beep) via a speaker on a right side of the user's head to indicate an instruction for the user to move in a direction to the right of the user. To initiate the instruction for the user to follow the sound, sensory feedback 412A may be communicated via speakers of display free body wearable computing device 50. Sensory feedback 412A may include, for example, verbal instructions to the user to follow the sound while looking at object 404.

Thus, using the image capture plan shown in FIG. 4B, display free body wearable computing device 50 may provide a motion plan, that when performed by the user, may enable cameras of display free body wearable computing device 50 to capture a set of images for use in generating a three-dimensional model.

Turning to FIG. 4C, a third example diagram showing activity that may occur while movement of a user of display free body wearable computing device 50 is actively guided in accordance with an embodiment is shown.

As previously discussed in FIG. 4B, the user may have received audio instructions and/or sensory feedback to indicate instructions for the user, starting from user position 420A (shown in short-dashed lines), to move following motion plan 410 (shown in long-dashed lines). While the user is moving, one or more cameras of display free body wearable computing device 50 may capture images based on the image capture plan. For example, the one or more cameras may capture images by activating camera sensors according to the image capture plan (e.g., at certain locations, frequencies, etc.).

Additionally, while the user is moving, display free body wearable computing device 50 may monitor movement of the user. Movement of the user may be monitored, for example, by: (i) using any number and/or type of motion sensors (e.g., accelerometers, gyroscopes, etc.) of display free body wearable computing device 50, (ii) analyzing the images captured by a camera while the user is moving to identify features (e.g., landmarks) of the scene relative to the scope of interest, and/or performing any other actions.

Movement of the user may be compared to motion plan 410. If movement of the user is determined to diverge from motion plan 410, display free body wearable computing device 50 may provide any number and/or type of sensory feedback that may convey a change to conform movement of the user to motion plan 410. For example, based on user movement 422A that repositions the user to user position 420B (e.g., a location away from motion plan 410), display free body wearable computing device 50 may provide sensory feedback 412B. Sensory feedback 412B may include, for example, verbal instructions to remind the user to follow the sound (e.g., as indicated by spatial audio cues) of motion plan 410.

The type of sensory feedback provided to the user may be based on criteria regarding movement of the user. For example, a distance that the user diverges from the motion plan may be compared to a distance threshold that may determine the type of sensory feedback provided to the user. Consider a second scenario (not shown) in which a user movement positions the user a distance away from motion plan 410, and the distance is shorter than the distance between user position 420B and motion plan 410. In this second scenario, second sensory feedback may be provided to the user (e.g., a change in volume of spatial audio cues/sounds rather than verbal instructions).

Thus, using the method shown in FIG. 4C, display free body wearable computing device 50 may actively guide movement of the user to follow a motion plan indicated by an image capture plan. By doing so, images captured while the user moves along the motion plan may be more likely to include the fields of view required to generate a three-dimensional model with a desired level of quality.

Turning to FIG. 4D, a fourth example diagram showing activity that may occur while movement of a user of display free body wearable computing device 50 is actively guided in accordance with an embodiment is shown.

As previously discussed in FIG. 4C, a set of images may be captured by one or more cameras of display free body wearable computing device 50 while the user moves according to motion plan 410. As the set of images are captured, each image of the set of images may be analyzed and/or compared to a quality standard. The quality standard may include one or more quality standards from a group of quality standards and may be indicated in the image capture plan. The group of quality standards may include, for example, standards for (i) blur, (ii) light exposure, (iii) overlap (e.g., of object 404) between images captured, and/or any other qualities.

In FIG. 4D, user movement 422B (shown with a striped pattern) may include a user movement of a speed that may be incompatible with an image capturing setting (e.g., shutter speed, focus, etc.) of the one or more cameras of display free body wearable computing device 50. For example, user movement 422B by the user may be faster than a movement required to capture an image of a desired level of quality. The image captured while user movement 422B is performed may subsequently have a level of quality that does not meet the quality standard (e.g., is too blurry).

When the image is identified as not meeting the quality standard, display free body wearable computing device 50 may perform any number and/or type of actions to improve a likelihood of obtaining images based on the image capture plan. For example, display free body wearable computing device 50 may (i) discard the image (e.g., that does not meet quality standard), (ii) provide sensory feedback 412C, (iii) capture a replacement image for the image, and/or perform any other actions. Sensory feedback 412C may include, for example, verbal instructions for the user to move slower to reduce blur (e.g., of images captured).

Thus, using the method shown in FIG. 4D, display free body wearable computing device 50 may actively guide movement of the user to capture images that meet a quality standard. By doing so, images captured while the user moves along the motion plan may be more likely to meet quality standards required to generate a three-dimensional model with a desired level of quality.

Turning to FIG. 4E, a fifth example diagram showing activity that may occur while movement of a user of display free body wearable computing device 50 is actively guided in accordance with an embodiment is shown.

In FIG. 4E, user movement 422C may reposition the user from user position 420A (shown in short-dashed lines) to user position 420D (shown in solid lines). At user position 420D, an orientation of cameras of display free body wearable computing device 50 may not enable the cameras to capture images of object 404. For example, the user's head may be: (i) turned in a direction that may not be facing object 404, (ii) tilted, and/or any other orientation that may exclude object 404 from camera field of view 130. By being positioned and/or oriented as such, an image captured by display free body wearable computing device 50 at user position 420D may not meet a quality standard (e.g., focus on object 404 in the image).

To identify that the image does not meet the quality standard, each image of the set of images may be analyzed as each image is captured, as previously discussed in FIG. 4D. Based on the orientation of the user, the image captured at user position 420D may not include object 404. Therefore, display free body wearable computing device 50 may (i) discard the image (e.g., that does not include object 404), (ii) provide sensory feedback 412D, (iii) capture a replacement image for the image when movement of the user conforms based on sensory feedback 412D, and/or perform any other actions. Sensory feedback 412D may include, for example, verbal instructions for the user to focus on object 404. By conforming movement of the user based on information obtained from on sensory feedback 412D, display free body wearable computing device 50 may capture images that meet the quality standard (e.g., focus on object 404) for use in generating the three-dimensional model.

Thus, using the method shown in FIG. 4D, display free body wearable computing device 50 may actively guide movement of the user to capture images that meet a quality standard. By doing so, images captured while the user moves along the motion plan may be more likely to meet quality standards required to generate a three-dimensional model with a desired level of quality.

Any of the components illustrated in FIGS. 1A-2 may be implemented with one or more computing devices. Turning to FIG. 5, a block diagram illustrating an example of a data processing system (e.g., a computing device) in accordance with an embodiment is shown. For example, system 500 may represent any of data processing systems described above performing any of the processes or methods described above. System 500 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 500 is intended to show a high level view of many components of the computer system. However, it is to be understood that additional components may be present in certain implementations and furthermore, different arrangement of the components shown may occur in other implementations. System 500 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 500 includes processor 501, memory 503, and devices 505-507 via a bus or an interconnect 510. Processor 501 may represent a single processor or multiple processors with a single processor core or multiple processor cores included therein. Processor 501 may represent one or more general-purpose processors such as a microprocessor, a central processing unit (CPU), or the like. More particularly, processor 501 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 501 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 501, which may be a low power multi-core processor socket such as an ultra-low voltage processor, may act as a main processing unit and central hub for communication with the various components of the system. Such processor can be implemented as a system on chip (SoC). Processor 501 is configured to execute instructions for performing the operations discussed herein. System 500 may further include a graphics interface that communicates with optional graphics subsystem 504, which may include a display controller, a graphics processor, and/or a display device.

Processor 501 may communicate with memory 503, which in one embodiment can be implemented via multiple memory devices to provide for a given amount of system memory. Memory 503 may include one or more volatile storage (or memory) devices such as random access memory (RAM), dynamic RAM (DRAM), synchronous DRAM (SDRAM), static RAM (SRAM), or other types of storage devices. Memory 503 may store information including sequences of instructions that are executed by processor 501, or any other device. For example, executable code and/or data of a variety of operating systems, device drivers, firmware (e.g., input output basic system or BIOS), and/or applications can be loaded in memory 503 and executed by processor 501. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 500 may further include IO devices such as devices (e.g., 505, 506, 507, 508) including network interface device(s) 505, optional input device(s) 506, and other optional IO device(s) 507. Network interface device(s) 505 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 506 may include a mouse, a touch pad, a touch sensitive screen (which may be integrated with a display device of optional graphics subsystem 504), a pointer device such as a stylus, and/or a keyboard (e.g., physical keyboard or a virtual keyboard displayed as part of a touch sensitive screen). For example, input device(s) 506 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 507 may include an audio device. An audio device may include a speaker and/or a microphone array to facilitate voice-enabled functions, such as voice recognition, voice replication, digital recording, and/or telephony functions. Other IO devices 507 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 507 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 510 via a sensor hub (not shown), while other devices such as a keyboard or thermal sensor may be controlled by an embedded controller (not shown), dependent upon the specific configuration or design of system 500.

To provide for persistent storage of information such as data, applications, one or more operating systems and so forth, a mass storage (not shown) may also couple to processor 501. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 501, e.g., via a serial peripheral interface (SPI). This flash device may provide for non-volatile storage of system software, including a basic input/output software (BIOS) as well as other firmware of the system.

Storage device 508 may include computer-readable storage medium 509 (also known as a machine-readable storage medium or a computer-readable medium) on which is stored one or more sets of instructions or software (e.g., processing module, unit, and/or processing module/unit/logic 528) embodying any one or more of the methodologies or functions described herein. Processing module/unit/logic 528 may represent any of the components described above. Processing module/unit/logic 528 may also reside, completely or at least partially, within memory 503 and/or within processor 501 during execution thereof by system 500, memory 503 and processor 501 also constituting machine-accessible storage media. Processing module/unit/logic 528 may further be transmitted or received over a network via network interface device(s) 505.

Computer-readable storage medium 509 may also be used to store some software functionalities described above persistently. While computer-readable storage medium 509 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 528, components and other features described herein can be implemented as discrete hardware components or integrated in the functionality of hardware components such as ASICS, FPGAs, DSPs or similar devices. In addition, processing module/unit/logic 528 can be implemented as firmware or functional circuitry within hardware devices. Further, processing module/unit/logic 528 can be implemented in any combination hardware devices and software components.

Note that while system 500 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for obtaining information regarding a scene using a display free body wearable computing device, the method comprising:
identifying a scope of interest in the scene as indicated by a user of the display free body wearable computing device;
obtaining an image capture plan based on the scope of interest; and
actively guiding movement of the user based on the image capture plan to obtain a set of images depicting portions of the scene.

2. The method of claim 1, wherein identifying the scope of the interest comprises:
obtaining, using at least one camera of the display free body wearable computing device,
a first image depicting:
a first portion of the scene, and
a gesture introduced into the scene by the user; and
identifying, based on the gesture and the first portion of the scene, the scope of the interest in the scene.

3. The method of claim 2, wherein, in an instance of the obtaining of the first image where the gesture indicates interest of the user in an object present in the scene:
the scope of the interest is limited to the object.

4. The method of claim 2, wherein, in an instance of the obtaining of the first image where the gesture indicates general interest:
the scope of the interest is all of the scene.

5. The method of claim 2, wherein obtaining the image capture plan comprises:
identifying, based on the scope of the interest, a number of images usable to generate a three-dimensional model having a desired level of quality; and
for each image of the number of images, identifying a location and field of view for obtaining the respective image based on the three-dimensional model having the desired level of quality.

6. The method of claim 5, wherein obtaining the image capture plan further comprises:
obtaining, based on the number of images, the locations, and the fields of view, a motion plan that, when performed by the user, enables a set of images to be captured using the at least one camera that allow for the three-dimensional model having the desired level of quality to be generated.

7. The method of claim 1, wherein actively guiding movement of the user comprises:
monitoring movement of the user;
comparing the movement of the user to a motion plan indicated by the image capture plan; and
in an instance of the comparing where the movement of the user diverges from the motion plan:
providing, to the user, sensory feedback that indicates a change in the movement of the user, the change being adapted to conform the movement of the user to the motion plan.

8. The method of claim 7, wherein the sensory feedback comprises spatial audio adapted to focus attention of the user on the scope of interest.

9. The method of claim 7, wherein the sensory feedback comprises audio queues that convey the change in the movement to the user.

10. The method of claim 7, wherein actively guiding movement of the user comprises:
as the set of the images are obtained:
comparing each image of the set of images to a quality standard;
in an instance of the comparing where an image of the set of images does not meet the quality standard:
discarding the image of the images;
providing, to the user, second sensory feedback that indicates a change in the movement of the user, the change being adapted to enable obtaining of a replacement image for the image of the images.

11. The method of claim 1, further comprising:
providing computer-implemented services using the set of images.

12. The method of claim 11, wherein providing the computer-implemented services comprises:
generating a three-dimensional model using the set of images;
obtaining an insight using the three-dimensional model; and
using the insight to convey enhanced information regarding the scene to the user.

13. The method of claim 1, wherein the display free body wearable computing device comprises:
an integrated sensing and interaction component adapted to:
be positioned symmetrically on two portions of a user's head,
be positioned between ears and eyes of the user, and
capture a stereo image of at least a portion of a scene present in a field of view of the user;
an integrated computing, powering, and securing portion; and
an adjustment member adapted to position the integrated sensing and interaction component with respect to the integrated computing, powering, and securing portion.

14. The method of claim 13, wherein the integrated sensing and interaction component comprises:
a pair of cameras;
speakers;
a microphone array; and
a touch pad.

15. The method of claim 14, wherein the integrated sensing and interaction component is adapted to:
obtain the stereo image from the pair of cameras;
at least partially process the stereo image to obtain an image processing result;
identify an action to be performed based, at least in part, on the image processing result and a derived result from a remote entity, the derived result being based, at least in part, on the stereo image and/or the image processing result; and
use at least the speakers to perform the action.

16. The method of claim 14, wherein the pair of cameras comprise lenses configured to:
establish a camera line of sight that is parallel to a line of sight of the user; and
establish a camera field of view that comprises the field of view of the user.

17. The method of claim 14, wherein the stereo image comprises a pair of images of the scene, each of the images being captured at different angles and/or positions with respect to the scene by the pair of cameras.

18. A non-transitory machine-readable medium having instructions stored therein, which when executed by a processor, cause the processor to perform operations for obtaining information regarding a scene using a display free body wearable computing device, the operations comprising:
identifying a scope of interest in the scene as indicated by a user of the display free body wearable computing device;
obtaining an image capture plan based on the scope of interest; and
actively guiding movement of the user based on the image capture plan to obtain a set of images depicting portions of the scene.

19. The non-transitory machine-readable medium of claim 18, wherein identifying the scope of the interest comprises:
obtaining, using at least one camera of the display free body wearable computing device,
a first image depicting:
a first portion of the scene, and
a gesture introduced into the scene by the user; and
identifying, based on the gesture and the first portion of the scene, the scope of the interest in the scene.

20. A data processing system, comprising:
a processor;
and a memory coupled to the processor to store instructions, which when executed by the processor, cause the processor to perform operations for obtaining information regarding a scene using a display free body wearable computing device, the operations comprising:
identifying a scope of interest in the scene as indicated by a user of the display free body wearable computing device;
obtaining an image capture plan based on the scope of interest; and
actively guiding movement of the user based on the image capture plan to obtain a set of images depicting portions of the scene.
